(19) United States
(12) Patent Application Publication
(10) Pub. No.: US 2010/0318918 A1
(43) Pub. Date: Dec. 16, 2010

(54) Communication Path Exchange Service

(76) Inventor: Alireza Mahmoodshahi, Annapolis, MD (US)

Correspondence Address: PROSKAUER ROSE LLP, ONE INTERNATIONAL PLACE, BOSTON, MA, 02110, US

(21) Appl. No.: 12/485,890

(22) Filed: Jun. 16, 2009

(51) Int. Cl. G06F 3/048; G06F 7/06; G06F 3/00; G06F 17/30

(52) U.S. Cl. 715/744; 715/780; 715/810; 715/846; 715/752; 715/753; 707/609; 707/769; 707/704

(57) ABSTRACT

Described are methods and apparatuses, including computer program products, for determining available communication paths. A graphical user interface is transmitted from a server device to a client device. The graphical user interface includes one or more graphical elements associated with one or more communication path attributes. One or more communication path request criteria based on input to at least one of the one or more graphical elements are received at the server device. The one or more communication path request criteria are associated with the one or more communication path attributes. Based on the one or more communication path request criteria, a ranked set of one or more available communication paths are determined. The ranked set of one or more available communication paths are transmitted from the server device to the client device.

### FIELD OF THE INVENTION

The present invention relates generally to computer-implemented methods and apparatuses, including computer program products, for determining available communication paths.

### BACKGROUND OF THE INVENTION

Communication carriers often need to connect to one another to achieve their business goals. For example, to support enterprise customers with geographically dispersed sites, wire line carriers typically contract with one another to reach locations where they do not offer coverage. In another example, wireless carriers typically contract with wire line carriers to implement or expand mobile back-haul networks. Typically, the interconnection of communication carriers is done on an ad hoc basis and independently between each participating party. Unilateral or bilateral agreements must be drafted for each interconnection that provide for the details of the connection (e.g., demark, interworking, management, etc.) and of the contract (e.g., pricing, service level agreement, etc.).

### SUMMARY OF THE INVENTION

One approach to interconnecting networks is to allow operators to determine available communication paths. In one aspect, there is a computerized method for determining available communication paths. The method includes transmitting, from a server device, a graphical user interface to a client device. The graphical user interface includes one or more graphical elements associated with one or more communication path attributes. The method also includes receiving, at the server device, one or more communication path request criteria based on input to at least one of the one or more graphical elements. The one or more communication path request criteria are associated with the one or more communication path attributes. The method also includes determining, based on the one or more communication path request criteria, a ranked set of one or more available communication paths. The method also includes transmitting, from the server device, the ranked set of one or more available communication paths to the client device.

In another aspect, there is a system for determining available communication paths. The system includes a server device configured to transmit a graphical user interface to a client device. The graphical user interface includes one or more graphical elements associated with one or more communication path attributes. The server device is also configured to receive one or more communication path request criteria based on input to at least one of the one or more graphical elements. The one or more communication path request criteria are associated with the one or more communication path attributes. The server device is also configured to determine, based on the one or more communication path request criteria, a ranked set of one or more available communication paths. The server device is also configured to transmit the ranked set of one or more available communication paths to the client device.

In another aspect, there is a computer program product. The computer program product is tangibly embodied in a machine-readable storage device and includes instructions being operable to cause a data processing apparatus to transmit, from a server device, a graphical user interface to a client device. The graphical user interface includes one or more graphical elements associated with one or more communication path attributes. The computer program product also includes instructions being operable to cause the data processing apparatus to receive, at the server device, one or more communication path request criteria based on input to at least one of the one or more graphical elements. The one or more communication path request criteria are associated with the one or more communication path attributes. The computer program product also includes instructions being operable to cause the data processing apparatus to determine, based on the one or more communication path request criteria, a ranked set of one or more available communication paths. The computer program product also includes instructions being operable to cause the data processing apparatus to transmit, from the server device, the ranked set of one or more available communication paths to the client device.

In other examples, any of the aspects above can include one or more of the following features. The server device can receive order information from the client device. The order information can identify a selected communication path from the ranked set of one or more available communication paths. The server device can receive a save request from the client device. The one or more communication path request criteria and/or at least a part of the ranked set of one or more available communication paths can be stored in a computer storage device, based on the save request.

In some embodiments, the ranked set of one or more available communication paths can include a search results graphical user interface. The search results graphical user interface can include an ordered list of the one or more available communication paths and one or more graphical filter elements associated with at least one of the one or more communication path attributes. The server device can receive one or more filtered communication path request criteria based on input to at least one of the one or more graphical filter elements. The ranked set of one or more available communication paths can be filtered based on the one or more filtered communication path request criteria. The server device can transmit the filtered ranked set of one or more available communication paths to the client device.

The one or more graphical elements can include: one or more text prompts, one or more drop-down menus, one or more buttons, one or more sliders, or any combination thereof. A first graphical element of the one or more graphical elements can be associated with a first communication path attribute of the one of the one or more communication path attributes. The first graphical element can include a graphical prompt enabling a user to define a first communication path request criteria of the one or more communication path request criteria. The first communication path request criteria can define a first search domain of the first communication path attribute. The first search domain can include: a maximum value, a minimum value, or any combination thereof. The first search domain can include a set of one or more values.

In some embodiments, the one or more communication path attributes can include: one or more location attributes, a time attribute, one or more quality attributes, a virtual circuit type attribute, a protocol attribute, a bandwidth attribute, a cost attribute, or any combination thereof. The one or more location attributes can be associated with one or more exchange switch locations. A first communication path criteria can be associated with the one or more location attributes. The first communication path criteria can identify at least a first exchange switch location. Each of the available communication paths in the ranked set of one or more available communication paths can include an exchange switch located at the first exchange switch location.

Determining the ranked set of one or more available communication paths can include determining, based on the one or more communication path request criteria, a base set of one or more available communication paths, and ranking the one or more available communication paths in the base set. Ranking the one or more available communication paths in the base set can include assigning one or more ranking values to the one or more available communication paths. The one or more ranking values can be based on a preferred communication path attribute. Determining the base set of one or more available communication paths can include retrieving, from an attribute database device, a set of matching communication paths. The attribute database device can include one or more searchable communication paths. Each of the one or more searchable communication paths can include one or more communication path attribute values associated with the one or more communication path attributes.

In some embodiments, the server device can receive a request from a communication path operator to update the attribute database device. The request can include a request to add a new communication path to the attribute database device. The new communication path can include one or more communication path attribute values associated with the one or more communication path attributes. The request can include a request to update an existing communication path in the attribute database device. The request to update can include updates to one or more existing communication path attribute values of the existing communication path. The server device can transmit an update request to a communication path operator database. The server device can receive a communication path update including one or more updates to the one or more searchable communication paths. The one or more updates can include updates to one or more existing communication path attribute values of the one or more searchable communication paths.

In another aspect, there is a computerized method for interconnecting communication networks. The method includes connecting a first communications network to a first exchange switch and connecting a second communications network to a second exchange switch. The first communications network is operated by a first carrier and the second communications network is operated by a second carrier different from the first carrier. The method also includes receiving, from the first carrier, a first set of one or more attribute values associated with available communication paths provided by the first communications network to the first exchange switch, and receiving, from the second carrier, a second set of one or more attribute values associated with available communication paths provided by the second communications network to the second exchange switch. The first and second sets of one or more attribute values can be stored in an attribute database. Data representative of a request to setup a communication path between the first and second communication networks using the first and second exchange switches can be received from a computing device associated with a buyer. The method can also include determining, based on the data representative of the request, a set of one or more available communication paths from the available communication paths provided by the first and second communication networks.

In some embodiments, the first and second exchange switches can be the same. In other embodiments, the first and second exchange switches can be different. A third communications network can be connected to the first exchange switch and the second exchange switch. The third communications network can be operated by a third carrier. At least one communication path from the set of one or more available communication paths can include at least a segment of the third communications network. The first and second communication networks can comply with minimum requirements before connecting to the first or second exchange switches.

In other examples, any of the features above relating to a method can be performed by a system, and/or a controller of the system, configured to or having means for performing the method. In addition, any of the features above relating to a method can be performed by a computer program product including instructions being operable to cause a data processing apparatus to perform the method. The server device, the client device and the computing device can each be single physical devices. Alternatively, the functionality of each device can be distributed to two or more physical devices, so that, for example, the server device is a collection of multiple physical devices that collectively incorporate all of the functionality performed by the server device, with communications between each of the devices as required to carry out the distributed functionality.

Any of the above implementations can realize one or more of the following advantages. Buyers of communication path(s) can advantageously visualize possible communication path(s), provider(s), attribute(s) to make more informed purchasing decisions. Buyers can advantageously perform “simulated” scenarios and searches of the connection path database to better understand the effect of selection criteria on available matching connection paths. Buyers can advantageously accelerate purchase decisions on communication path interconnect options. Similarly, buyers can advantageously use the exchange system to get the best cost and best matched communication in a one-step process. The exchange system can also allow buyers to reduce purchasing staff and resources. Sellers of communication path(s) can advantageously reach a broader market thru a global online portal and a centralized (or linked) communication path database. The exchange system advantageously can allow sellers to illustrate competitive advantage (vis-a-vis other carriers) through side-by-side comparison of features, service levels and/or overall matching criteria against customer searches of the communication path database. The exchange system also can accelerate sales for the seller thru this global electronic channel. Similarly, the exchange system can allow sellers to reduce sales/marketing staff and/or resources. The exchange system, with respect to the overall communications industry, can accelerate the growth of the carrier communication path interconnection market through a global, online exchange and centralized (or linked) database. In addition, the exchange system can allow carriers to lower overall infrastructure network cost, because the operators of the carriers do not have to invest in creating unilateral and/or bilateral network-to-network interface connections.

The details of one or more examples are set forth in the accompanying drawings and the description below. Further features, aspects, and advantages of the invention will become apparent from the description, the drawings, and the claims. The drawings are not necessarily to scale, emphasis instead generally being placed upon illustrating the principles of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing an exemplary network with devices relating to the interconnection of communication carriers.

FIG. 2 is a block diagram showing connections between an exchange switch and networks.

FIG. 3 is a block diagram showing an exemplary exchange operator system.

FIG. 4 illustrates a flowchart depicting the interconnection of communication networks.

FIG. 5 illustrates a flowchart depicting the determination of available communication paths.

FIGS. 6A-B illustrate exemplary graphical user interfaces relating to the determination of available communication paths.

FIGS. 7A-B illustrate graphical user interfaces relating to the determination of available communication paths according to one embodiment.

FIGS. 8A-B are block diagrams showing a point-to-multipoint communication path.

FIGS. 9A-B are block diagrams showing a multipoint-to-multipoint communication path.

### DESCRIPTION OF THE INVENTION

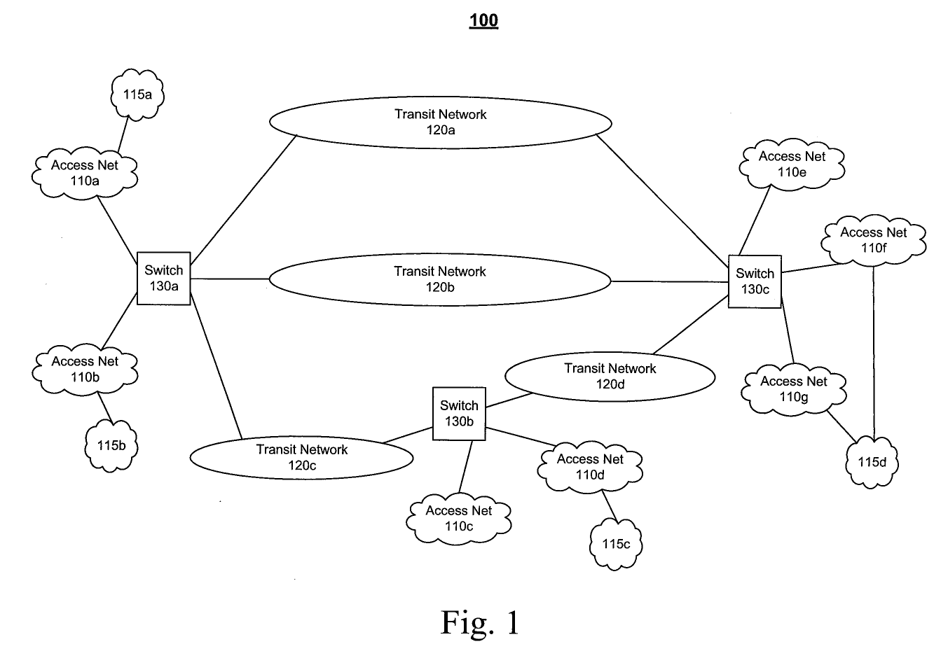

FIG. 1 is a block diagram showing an exemplary network 100 with devices relating to the interconnection of communication networks. The network 100 includes one or more access networks 110a, 110b, 110c, 110d, 110e, 110f, 110g, generally 110, one or more transit networks 120a, 120b, 120c, 120d, generally 120, one or more exchange switches 130a, 130b, 130c, generally 130, and/or one or more customer networks 115a, 115b, 115c, 115d, generally 115.

In some embodiments, an access network 110 can be operated by a local operator (e.g., a local exchange carrier (LEC) and/or local service provider). For example, a local operator can include a local wire line carrier and/or a wireless carrier that provide “last mile” connectivity within a geographic area. In some embodiments, an access network 110 can span across geographical regions ranging from intra-campus connectivity, to intra-city connectivity, to city-to-city connectivity (e.g., local haul carriers). Each access network 110 can be operated by different operators. For example, access network 110a can be operated by a communication carrier for the city of Boston, whereas access network 110b can be operated by a communication carrier for the city of Los Angeles. FIG. 1 illustrates that each access network 110 is connected to a single exchange switch 130, but other configurations can also be used. For example, access networks 110 can generally be connected to one or more exchange switches 130.

In some embodiments, a transit network 120 can be operated by a regional or long-distance operator (e.g., an interexchange carrier (IXC) and/or other long-distance service provider). For example, a transit operator can include a carrier that provides long-distance connectivity across geographic areas. In some embodiments, a transit network 120 can span across geographical regions ranging from inter-regional connectivity, to national connectivity, to global connectivity (e.g., long-haul carriers). Each transit network 120 can be operated by different operators. For example, transit network 120a can be operated by AT&T, whereas transit network 120b can be operated by Verizon. FIG. 1 illustrates that each transit network 120 is connected to two exchange switches 130, but other configurations can also be used. For example, transit networks 120 can generally be connected to two or more exchange switches 130. In some embodiments, a communications network operator can provide both access and transit services. For example, an operator can own and operate a local access network (e.g., 110d) and a transit network (e.g., 120d).

In some embodiments, a customer network 115 can be operated by a particular organization (e.g., a corporation, an educational institution, and/or other associations). In one example, a customer network 115 can be a local intranet providing connectivity within a single building or across a campus of buildings. In another example, a customer network 115 can be a wireless network (e.g., a mobile back-haul network including one or more base stations controlled by a base station controller). The customer networks 115 can be enterprise customers of the access networks 110. For example, the customer networks 115 can contract with the operator of an access network 110 to provide services and/or access to remote networks (e.g., the Internet and/or other remote customer networks 115). In another embodiment, a customer network 115 can connect directly to an exchange switch 130. In some embodiments, a customer network can connect to two or more access networks 110 (e.g., the customer network 115d is connected to both the access network 110f and the access network 110g).

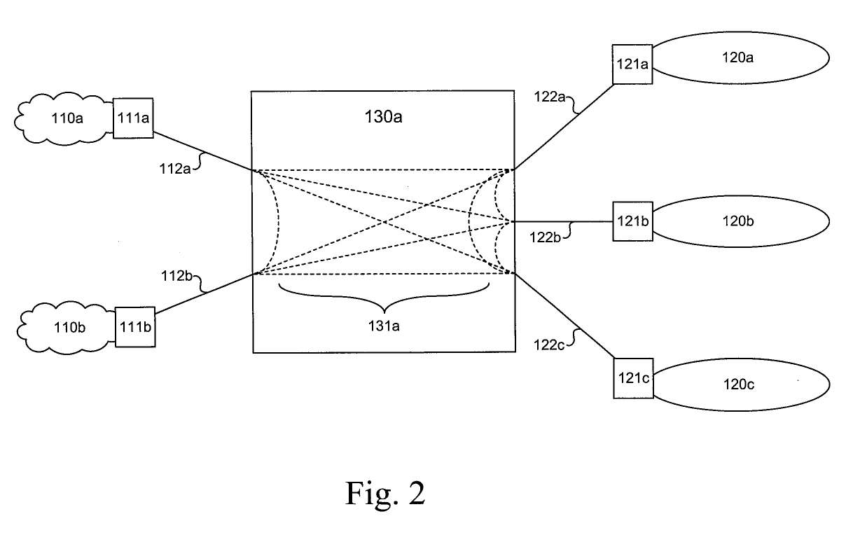

Generally, an exchange switch 130 can connect two or more different communication networks operated by different operators. The exchange switches 130 can be strategically located around the country and/or the world (e.g., at points of presence (POP)). FIG. 2 is a block diagram showing the connections between the exchange switch 130a and networks 110a, 110b, 120a, 120b and 120c of FIG. 1. The access networks 110a and 110b can connect to the exchange switch 130a via respective physical connections 112a and 112b from network equipment 111a and 111b (e.g., a router device, a gateway device, a network border switch, and/or the like). Similarly, the transit networks 120a, 120b and 120c can connect to the exchange switch 130a via respective physical connections 122a, 122b and 122c from network equipment 121a, 121b and 121c. Physical connections can attach to the exchange switch 130a via, for example, an optical or a copper interface. The interfaces of the exchange switch 130a can support, for example, one or more of 1 Gbps or 10 Gbps Ethernet, SONET/SDH, MPLS, ATM, and/or other connection types. In some embodiments, the exchange switch 130a can translate one or more protocols (e.g., legacy protocols) to a predetermined default protocol (e.g., Ethernet) via a gateway. In some embodiments, translation to a default protocol such as Carrier Ethernet advantageously can allow all connections, within the core of an exchange switch 130, to be Carrier Ethernet.

In some embodiments, the exchange switch 130a can be a layer-2 Ethernet switch. In one example, the MAC forwarding table of the exchange switch 130a does not have to be built from packet flooding and self-learning. Rather, the forwarding table can be provisioned manually by the operator of the exchange switch 130a based on interconnect circuit orders from carrier customers.

As discussed in more detail below, the exchange switch 130a can setup communication paths by setting up one or more logical connections 131a between two or more physical connections attached to the exchange switch 130a. For example, the exchange switch 130a can interconnect one or more networks by building Component Ethernet Virtual Circuits (CEVCs) between two or more of their physical ports. In an alternative or supplemental embodiment, an exchange switch 130 can provide one or more services for setting up, maintaining, and/or tearing down communication paths between one or more access networks 110. A communication path can be a dedicated circuit such as, for example, a virtual circuit. In general, a communication path can be any dedicated physical or logical connection. For example, a logical communication path can be any data link layer connection (e.g., an Ethernet communication path), a network layer connection (e.g., an IP or IP/MPLS communication path), a connection of one or more layers collapsed together (e.g., IP or IP/MPLS collapsed with Ethernet, or layer 2 collapsed with layer 3), or any hybrid thereof (e.g., a hybrid data link/network layer communication path). In some embodiments, a communication path can include one or more communication path segments of the same or of different types. For example, a communication path from the customer network 115a to the customer network 115c can include a first communication path segment in the access network 110a, a second communication path segment in the transit network 120c, and a third communication path segment in the access network 110c. Communication path segments can be physically and/or logically connected to one another at the exchange switches 130. As described in more detail below, communication paths can include point-to-point communication paths, point-to-multipoint communication paths, and/or multipoint-to-multipoint communication paths.

In an alternative or supplemental embodiment, exchange switches 130 can perform gateway and/or aggregation functions for interconnecting one or more connected communication networks. For example, an exchange switch 130 can perform gateway functions for various incoming protocols such as Ethernet, Ethernet over MPLS, Ethernet over ATM, Ethernet over SDH, Ethernet over SONET, Frame, ATM, and/or other networking protocols. In some embodiments, exchange switches 130 can provide high-speed switching of aggregated links of speeds 1 GbE or 10 GbE over access networks 120.

To promote interoperability and end-to-end manageability, connections to the exchange switches 130, and/or the communication paths subsequently setup over the exchange switches 130, can comply with Ethernet industry standards (e.g., the External Network-to-Network Interconnection (E-NNI) standard as established by the Metro Ethernet Forum (MEF)). In a supplemental embodiment, exchange switches 130 can certify and/or monitor each connected network's level of compliance to these standards, which can advantageously provide a 3^{rd}-party validation service.

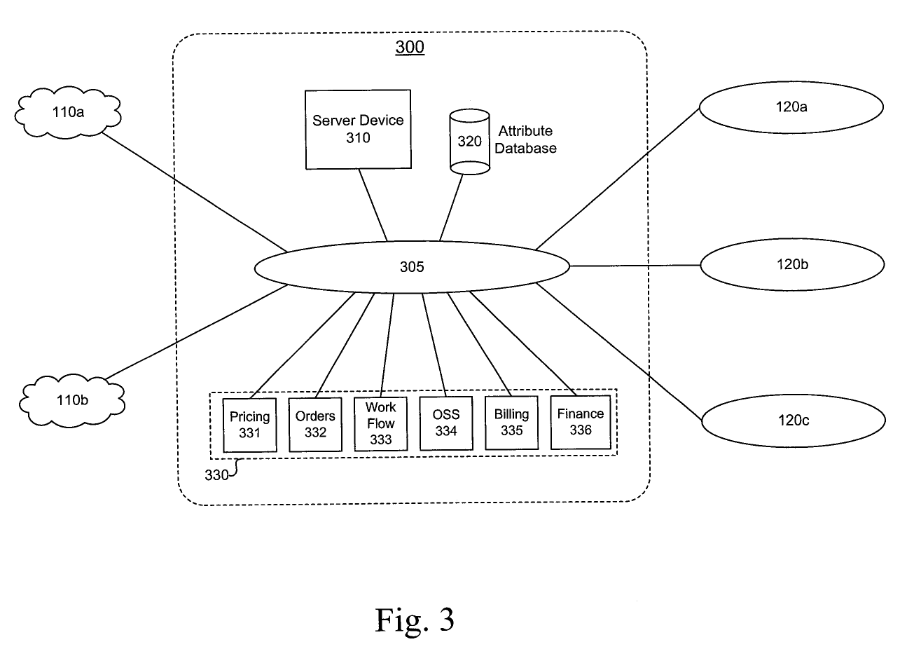

FIG. 3 is a block diagram showing an exemplary exchange operator system 300. The elements of the exchange operator system 300 are described using the exemplary network 100 of FIG. 1. Generally, the exchange operator system 300 can be responsible for the management and operation of setting up, maintaining, and/or tearing down communication paths between access networks 110. The exchange operator system 300 can include an interconnection network 305, a server device 310, an attribute database 320, and/or one or more additional backend databases and/or servers 330. The interconnection network 305 can include one or more exchange switches 130 for interconnecting one or more of the access and/or transit networks 110 and 120. In one embodiment, the interconnection network 305 can be connected to the access networks 110 and to the transit networks 120 as illustrated in FIG. 1.

In some embodiments, the exchange operator system 300 can provide a service that allows access networks 110 to connect to one another to achieve business goals. For example, to support enterprise customers with geographically dispersed sites (e.g., customer networks 115a and 115d), wire line carriers such as access networks 110a, 110g and 120b typically will contract with one another in order to setup a communication path to reach locations where they do not offer coverage. In another example, wireless carriers typically contract with wire line carriers to implement and/or expand mobile back-haul networks.

The exchange operator system 300 can advantageously make the process of network-to-network (e.g., carrier-to-carrier) interconnection more expedient and cost effective. Generally, the exchange operator system 300 can be a centralized hub to which many communication networks can connect to for offering their network infrastructure to exchange traffic for mutual benefit. By strategically locating exchange switches 130 and interconnecting them via one or more transit networks 120, an access network 110 can then connect to the nearest exchange switch 130 and easily interconnect to any location covered by the exchange operation system 300. In addition, the access networks 110, as buyers of communication paths, will advantageously have the option to select among many available communication paths based on a set of one or more criteria that best suits their customer network's needs. For example, if customer network 115a (e.g., a customer of access network 110a) wants to setup a communication path to customer network 115d, the buyer of the communication (e.g., the operator of access network 110a) can have the option to purchase communication services from either transit network 120a, transit network 120b, or transit networks 120c and 120d.

As sellers of services, both access networks 110 and transit networks 120 can advantageously be able to sell unused bandwidth of their network infrastructure using the services provided by the exchange operator system 300. For example, transit networks 120 can charge buyers of services for setting up communication paths over their network infrastructure. Similarly, access networks 110 can charge buyers of services for setting up communication paths to customer networks 115 directly connected to their network. For example, if customer network 115a (e.g., a customer of access network 110a) wants to setup a communication path to customer network 115d, the operator of access network 110g can charge the buyer for use of their network infrastructure. In one embodiment, the exchange operator system 300 can be operated by one of the transit networks 120.

The server device 310 can be responsible for interacting with the operators of access networks 110 and/or transit networks 120 (as sellers and/or buyers of communication paths), and/or other buyers or sellers of communication paths (e.g., operators of communication networks 115). In some embodiments, the server device 310 can process requests from buyers to search for available communication paths (based on specified criteria and a search algorithm as described below) and/or order the provisioning of the a selected communication path. Provisioning services can include, for example, the establishment, maintenance, and/or teardown of communication paths over the interconnection network 305. In an alternative or supplemental embodiment, the server device 310 can process requests from sellers to update and/or otherwise modify the available communication paths and/or services that they offer. The server device 310 can also provide reports on existing connections, services and/or other information such as billing, based on interaction with backend systems 330.

The server device 310 can include, for example, a web server that hosts one or more web sites available to buyers and/or sellers. In some embodiments, the server device 310 can be co-located with, or directly connected to, an exchange switch 130. In other embodiments, the exchange operator system 300 can include two or more server devices 310 geographically distributed across the interconnection network 305. FIG. 3 illustrates that the server device 310 is connected to the interconnection network 305, but other configurations can be used. For example, the server device 310 can be connected to the Internet. More generally, the server device 310 can be connected to any communications network in which buyers and/or sellers can access via a client device (not shown). Client devices can include, for example, a web browser running on a computer.

The attribute database 320 can include communication path attribute values for each communication path offered by an access network 110 and/or transit network 120 connected to the interconnection network 305. The attribute database 320 can also include exchange switch 130 attributes such as, for example, what communication path attributes a particular exchange switch 130 is able to support. Communication path attributes can include, for example, those listed in Attachment A listed at the end of the specification, and the like. In some embodiments, the attribute database 320 is centrally located. In an alternative or supplemental embodiment, the attribute database 320 can be a distributed attribute database. For example, separate attribute databases can be located region-by-region, or country-by-country. The communication path attribute values stored in the attribute database can logically be divided into separate sub-databases based on one or more communication path attributes. For example, an attribute database 320 can include a sub-database of cost attribute values associated with respective communication paths and a sub-database of location attribute values associated with respective communication paths.

In some alternative or supplemental embodiments, an attribute database (not shown) can be co-located with or directly associated with an exchange switch 130. An exchange switch attribute database can include attribute values for communication paths associated with that exchange switch. For example, an exchange switch attribute database can include a list of the carriers that are connected to the switch, the certifications required by each carrier for connection to the exchange, the lead time for physically connecting to the exchange and/or for completing certifications, the maximum and/or current switching capacity of the exchange, the historical and/or real time performance of all communication paths across the exchange switch, the availability of these communication paths, and/or any other communication path attribute.

The service level agreement (SLA) attribute (e.g., Gold, Bronze, baseline) can be used as service tiers to distinguish between basic and more advanced communication network service offerings. For example, present Carrier Ethernet standardization is not to the point where service interoperability and interworking is guaranteed. Many factors can contribute to determining whether or not an off-net Ethernet service is compatible with a given carrier's Ethernet service at the NNI, UNI or EVC level. Off-net services can be, for example, any services offered on a communications network outside of the existing network infrastructure operated by a particular carrier. The same can be true for determining which carrier among several compatible ones is the best match. Lacking any standards in this regard, the exchange operator system 300 can, in one embodiment, include three service tiers—bronze, silver and gold—to distinguish between basic and more advanced Carrier Ethernet service offerings. The attributes that make each service classification can be specified by the exchange operator system 300 in its attribute database 320.

Although shown as single logical entities, the server device 310 and the attribute database 320 can be combined into a single physical device or one or both of them can be distributed over several physical devices.

Backend functionality can include, for example, pricing 331, orders 332, work flow 333, OSS 334, billing 335, and/or finance 336, generally 330. More generally, backend systems 330 can provide services for provisioning, monitoring/management, billing, and/or other services.

FIG. 3 shows that the server device 310, the attribute database 320 and the backend functionality 330 are connected to the interconnection network 305, but other configurations can also be used. For example, a control network (not shown) separate from the interconnection network 305 can be used to interconnect the server device 310, the attribute database 320, the backend functionality 330, and/or the exchange switches 130. The control network can be used for monitoring, management and control of the exchange operator system 300.

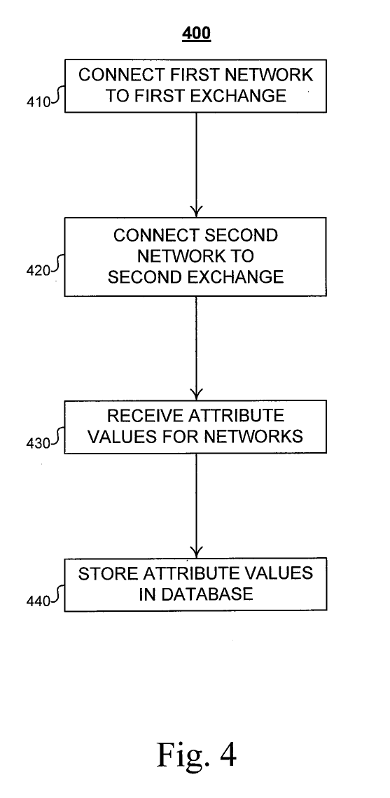

FIG. 4 illustrates a flowchart 400 depicting the interconnection of communication networks. The elements of flowchart 400 are described using the exemplary network 100 of FIG. 1. The interconnection of communication networks includes connecting a first communications network to a first exchange switch (410), connecting a second communications network to a second exchange switch (420), receiving one or more sets of attribute values associated with the available communication paths provided by the first and/or second communication networks (430), and storing the one or more sets of attribute values in the attribute database 320 (440). The communication networks can include any of the networks described herein, including, for example, transit networks, access networks, customer networks, and the like. The attributes can include any of the attributes described herein and the like.

The first communications network can be operated by a first carrier. For example, as illustrated in FIG. 1, the operator of access network 110a can contract with the operator of the exchange switch 130a to provide and/or use the interconnection services offered by the exchange operator system 300. Similarly, the second communications network can be operated by a second carrier. In some embodiments, the second carrier can be different from the first carrier. Returning the example of FIG. 1, the operator of access network 110g can contract with the operator of the exchange switch 130c to provide and/or use the interconnection services offered by the exchange operator system 300. In this case, the first and second exchange switches are different, but different communication networks can also connect to the same exchange switch. For example, the operator of access network 110b can contract with the operator of the exchange switch 130a to connect to the access network 110a.

Referring to network 100, connection by a new communications network (not shown) located in Boston, for example, to exchange switch 130c would advantageously allow the new communications network to have access to setup dedicated communication paths to all areas served by the existing set of providers (e.g., areas covered by existing access networks 110a-110g). The existing access networks 110a-110g would also, advantageously, gain access to the new communication network's territory (e.g., Boston) through the exchange switch 130c.

In some embodiments, the access or transit communications network that connects to the exchange operator system 300 can pay a one-time connection fee and thereafter pay a monthly port charge based on the connection speed. The exchange operator system 300 can further be paid a recurring fee by the connected communications network for completing and/or maintaining each existing communication path within the exchange operator system 300.

In alternative or supplemental embodiments, access and/or transit communication networks could pay a premium to connect to the exchange operator system 300 via non-Ethernet media/transport technologies (e.g., EoSONET/SDH, Frame, ATM, etc.). The access and/or transit communication networks could also pay a fee to have the exchange operator system 300 certify that their service is compliant to a “baseline” connection configuration and one of the Bronze, Silver, or Gold service classifications discussed below.

One challenge facing communication networks today is finding and setting up compatible connections outside of their own network infrastructure (e.g., off-net connections such as Ethernet connections). Establishing, for example, an External Network-to-Network Interface (E-NNI) with another carrier can require months of effort working out mappings between different implementations. The exchange operator system 300 advantageously can address this challenge by providing an online search engine that allows operators of communication networks to search for available communication paths based on specified criteria.

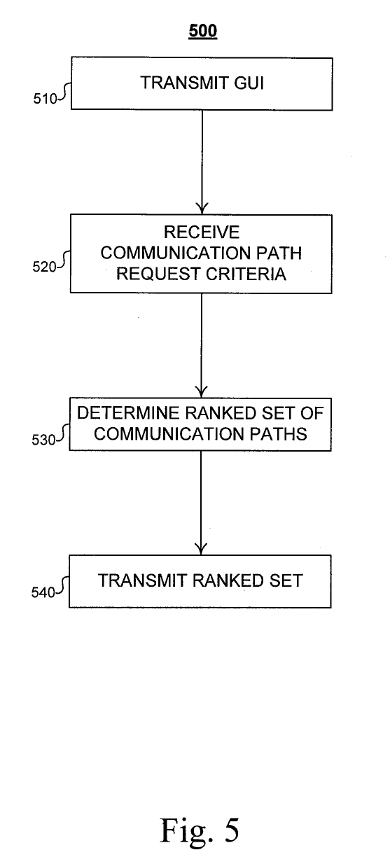

FIG. 5 illustrates a flowchart 500 depicting the determination of available communication paths. The elements of flowchart 500 are described using the exemplary network 100 of FIG. 1. The determination of available communication paths includes transmitting, from a server device, a graphical user interface to a client device (510), receiving, at the server device, one or more communication path request criteria based on input to at least one of the one or more graphical elements (520), determining, based on the one or more communication path request criteria, a ranked set of one or more available communication paths (530), and transmitting, from the server device, the ranked set of one or more available communication paths to the client device (540).

Generally, the graphical user interface can allow a user (e.g., a buyer) to enter technical and/or commercial criteria for communication paths in order to search for compatible and/or best matching off-net communication paths. The buying customer can first enter the desired criteria and can optionally save these criteria to their account profile for future use. The communication path search criteria can be any subset of the communication path attributes listed in Attachment A, and the like. Once satisfied with the communication path search criteria, the user can execute the search function. The server device 310 can receive the communication path search criteria (520) and initiate a scan of the attribute database(s) 320 to identify, sort and/or present all available communication paths, or a subset thereof, that match the input search criteria (530). For example, the server device 310, by default or by a modifiable user preference, can limit the set of available communication paths presented to the user to a predetermined number. The exchange operator system 300 can use a proprietary algorithm to do its filtering and “best-match” calculations.

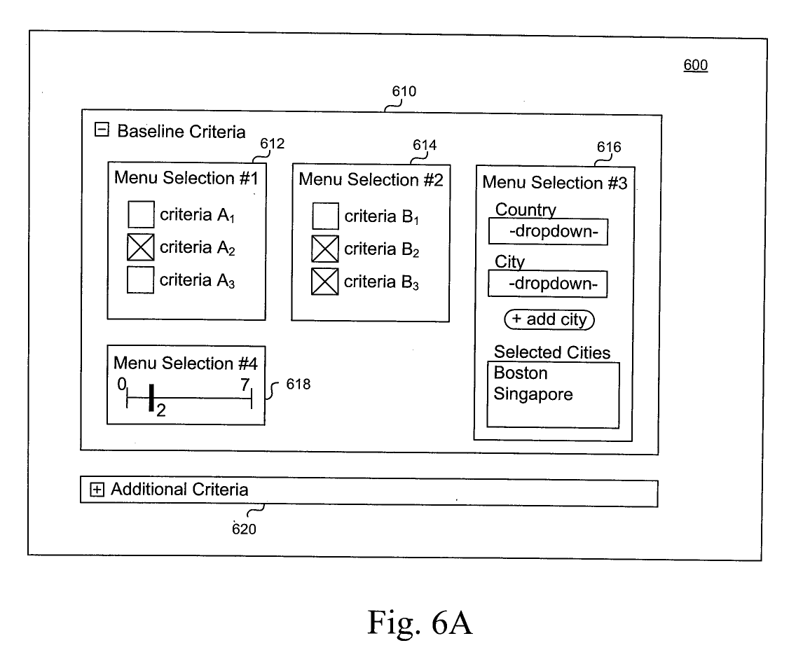

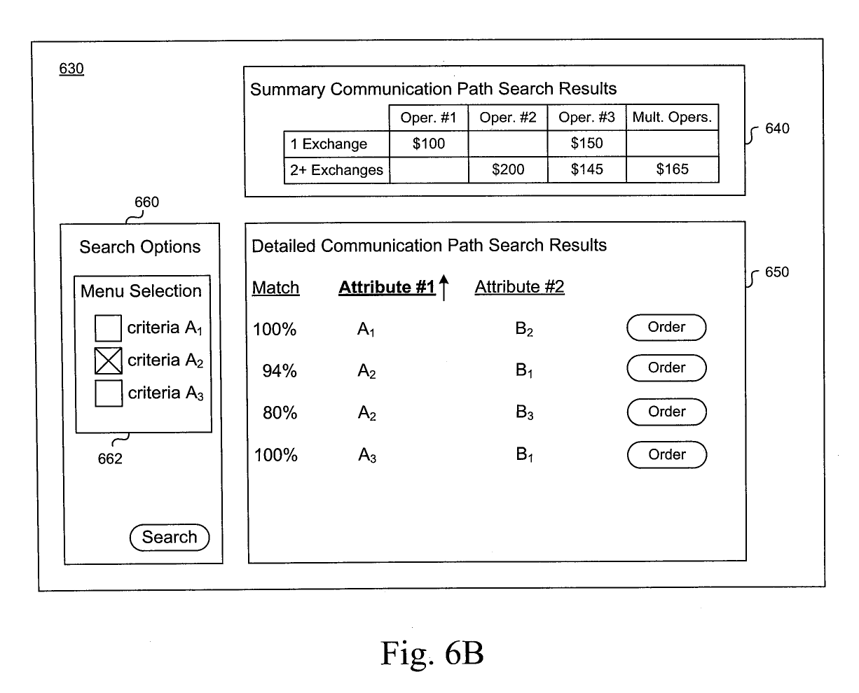

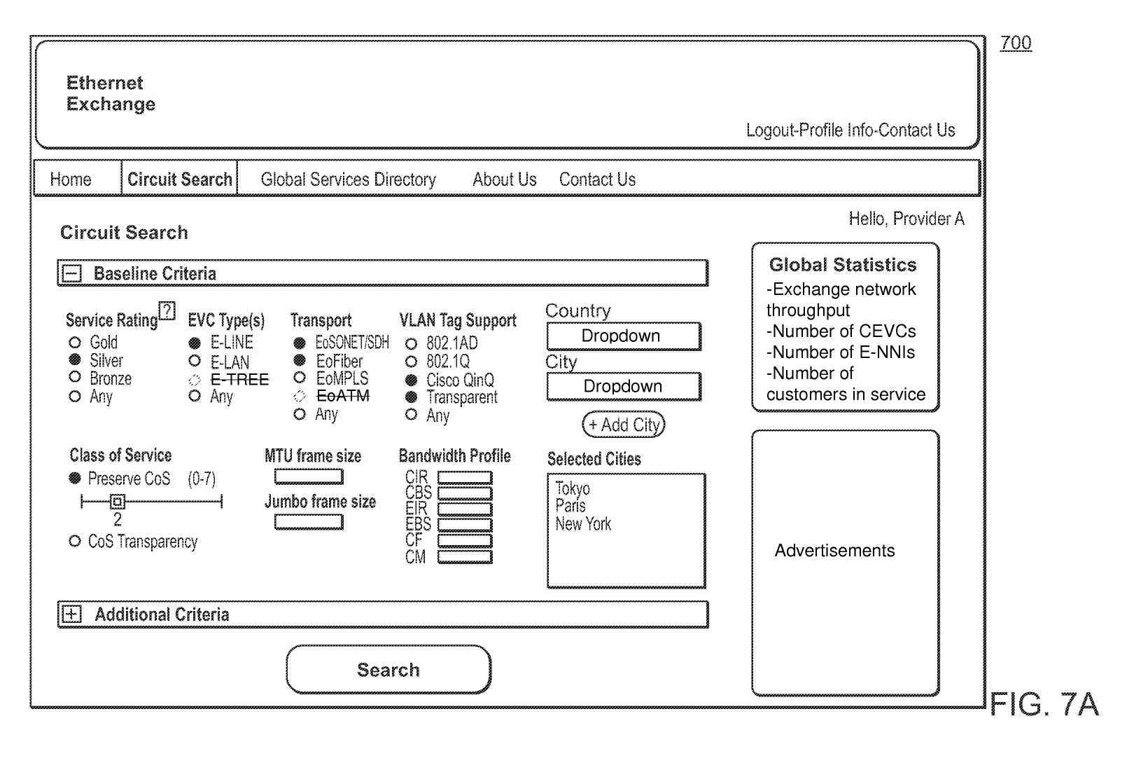

FIG. 6A illustrates an exemplary graphical user interface 600 relating to the determination of available communication paths. The graphical user interface 600 includes a baseline criteria graphical element 610 and an optional additional criteria graphical element 620. The baseline criteria graphical element 610 includes graphical elements 612, 614, 616, and 618, but other configurations can also be used. For example, the baseline criteria graphical element 610 can include one or more graphical selection elements. Each graphical element can be associated with one or more communication path attributes. For example, graphical element 612 is associated with the attribute ‘A’, graphical element 614 is associated with the attribute ‘B’, graphical element 616 is associated with a location attribute, and graphical element 618 is associated with, for example, a Class of Service (CoS) level. Baseline attributes can include, for example, a set of standard attributes by which all carriers must provide for their offered communication paths when connecting to an exchange switch 130.

Generally, graphical elements can include one or more text prompts, one or more drop-down menus, one or more buttons, one or more sliders (e.g., with a min slider, a max slider, or both), or any other graphical prompt that enables a user to define communication path request criteria for the associated communication path attribute. For example, in the graphical user interface 600, a user has selected communication path attributes ‘A₁’ for the ‘A’ attribute, ‘B₂’and ‘B₃’ for the ‘B’ attribute, Boston and Singapore for the location attributes, and ‘2’ for the CoS. Each defined communication path request criteria can subsequently be used as search domain values for searching for available communication paths that match the selected criteria.

FIG. 6B illustrates an exemplary graphical user interface 630 relating to the determination of available communication paths. The graphical user interface 630 can be, for example, a results graphical user interface that is transmitted back to the requesting user the results from the initial search using the graphical user interface of 600 of FIG. 6A. The graphical user interface 630 includes a summary communication path search results element 640, a detailed communication path search results element 650, and a search options element 660. The summary communication path search results element 640 includes a summary of communication path results based on the operator of the available communication path. For example, if the buyer in this case was an operator of an access network connected to the exchange switch 130c, then Operators #1-3 can represent one of the operators for each of the access networks 110e-110g, respectively, for which the available communication paths traverse (e.g., AT&T, Verizon, Global Crossing, etc.), whereas “Mult. Opers.” can represent the operator for the transit network 120d and one of the operators for the access networks 110c-110d for which a communication path must traverse two exchange switches (i.e., the exchange switches 130c and 130b).

The detailed communication path search results element 650 includes a ranked set of one or more available communication paths. In this case, the available communication paths are ranked, by default, according to the attribute #1, but the user has the option to rank the available communication paths by any attribute he or she so chooses. In addition to listing the attributes, the detailed communication path search results element 650 also lists a matching value for each available communication path. A matching value can be based on, for example, a weighted function of the number of attributes of the particular communication path match those of the criteria entered by the user. The user can have the option to specify a particular weighting value (e.g., give a higher matching consideration to price than to speed), and/or the weighting function can equally weight all attributes by default.

The search options element 660 can allow the user to filter the displayed search results by entering one or more additional communication path search criteria. Filtering the search results can include limiting the matched search results (by adding additional search criteria for new communication path attributes and/or by narrowing the search domain of previously entered communication path search criteria) or expanding the matched search results (e.g., by broadened the search domain of the communication path criteria).

The user can instruct the server device 310 to save the search results and/or the search criteria to his/her profile for later use or immediately place an interconnect order for a selected communication path with the exchange operator system 300. An order can include an order to purchase and provision the selected communication path or an order to provision the selected communication path (e.g., where the user had previously purchased the right to place one or more orders).

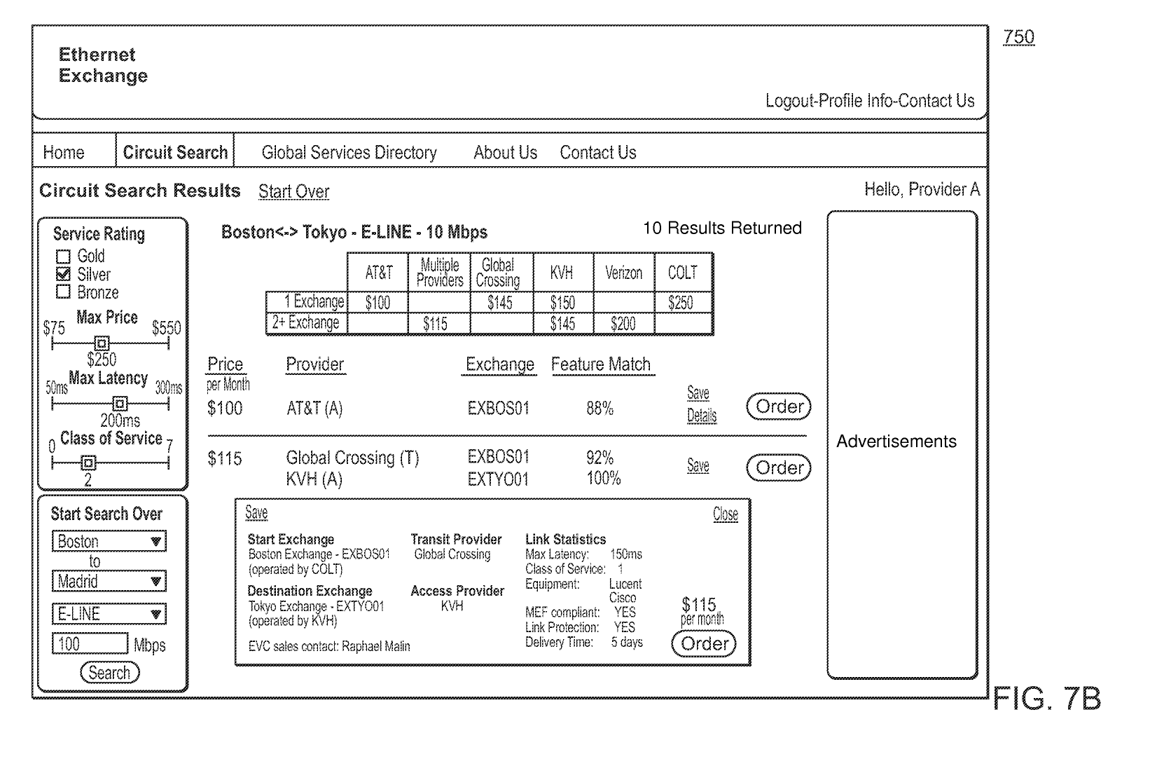

FIG. 7A illustrates a graphical user interface 700 of an exemplary interface for performing initial communication path searches. FIG. 7B illustrates a graphical user interface 750 of an exemplary interface for displaying search results, for performing an additional filter search, and/or for ordering a communication path.

Providers of communication paths (e.g., sellers) can also interact with the server device 310 (e.g., a web portal) or other device capable of updating the attribute database 320 (e.g., an FTP server). For example, the operators of access and/or transit networks 110 and 120 can send update requests to the exchange operator system 300 to update the attribute values stored in the attribute database 320 associated with the communication paths that they provide. In one embodiment, an update request can include a request to add a new communication path (along with its associated one or more attribute values) to the attribute database 320. In an alternative or supplemental embodiment, an update request can include a request to modify the attribute values of an existing communication path in the attribute database 320.

Determining the ranked set of one or more available communication paths (530) can include determining, based on the one or more communication path request criteria, a base set of one or more available communication paths, and then ranking the one or more available communication paths in the base set. For example, in one embodiment, the server device 310, upon receiving search criteria from a user, can query the attribute database 320 for all available communication paths that at least match one or more baseline search domain criteria. Next, the server device 310, or other backend system, can execute a ranking algorithm to assign one or more ranking values to the set of available communication paths. For example, the ranking values of the ranked list included in graphical element 650 is based on attribute #1.

Generally, setting up a communication path between different areas can require setting up communication paths through one or more exchange switches 130. Depending on the number and coverage of participating access and transit networks 110 and 120, there can be multiple communication paths available over transit networks 120 and multiple communication paths available over access networks 110 from which to choose to complete the desired communication path. The exchange operator system 300 can employ a “best-path” algorithm as part of its search function to identify all possible paths and calculate the best candidate(s). The algorithm can factor in number of transit and access hops, performance characteristics of each hop, overall price, service delivery intervals and/or other variables.

Tables I-IV illustrate a high-level example of the best-path algorithm. For example, Table I can illustrate what a customer has transmitted to the server device 130 regarding the desired Carrier Ethernet service type (E-LINE), origin and destination locations (customer networks 115a and 115d), and service class (Gold). The exchange operator system 300 can search the attribute database of connections and connection attributes to find matching hops and then end-to-end routes between customer networks 115a and 115d. Table II can illustrate the attribute values that the operators of access and transit networks have provided to the attribute database 320 for the communication paths that support E-LINE (i.e., the communication paths listed in Table II can illustrate the contents of the attribute database 320 with the non-E-LINE communication paths filtered out). Values for communication path attributes can previously have been uploaded to the attribute database 320 by the operators of the access and/or transit networks 110 and 120, or the server device 310 can query one or more attribute databases (not shown) of the access and/or transit networks 110 and 120 upon receipt of a user's request for most up-to-date communication path information. Taken together, the best-path algorithm can take one or more values from Tables I-II as input in determining one or more ranked communication paths. In other examples, any of the attributes described herein can be used in determining the ranked communication paths that best match the user criteria.

TABLE I
User Inputs

| Type | From | To | Class |
|---|---|---|---|
| E-LINE | 115a | 115d | Gold |

TABLE II
Carrier Inputs (e.g., Attribute Database 320)

| Carrier | SLAs | Cost |
|---|---|---|
| 110a | Baseline | n/a |
| | Gold | n/a |
| 120a | Baseline | $ |
| 120b | Baseline | $ |
| | Bronze | $$ |
| | Gold | $$$ |
| 120c | Baseline | $ |
| | Bronze | $$ |
| 120d | Baseline | $ |
| 120e | Baseline | $ |
| 110f | Baseline | $ |
| | Gold | $$$ |
| 110g | Baseline | $ |
| | Gold | $$ |

The “best-path” algorithm used to determine the best match between a request and alternate Carrier Ethernet services (either within a single exchange switch and/or across multiple exchange switches) can be an optimization function. The mathematical function can be solved to find a minimum value (e.g., least cost, lowest latency), a maximum value (e.g., number of supported quality-of-service and/or priority levels), a particular value (e.g., preferred carrier, or Service Rating), or any combination of one or more of these values. To compute an overall best match, these values can, for example, be normalized, weighted and summed with the weightings being assigned either by the customer through a graphical user interface or by a predetermined setting.

Tables III illustrates the calculation of determining the available communication paths. In this example, customer network 115d is connected to both access networks 110f and 110g (e.g., customer network 115d is located in New York city, to which both access networks 110f and 110g provide coverage). In this example, since the network 120a only supports communication paths that meet the baseline SLA, then only two communication paths are available that traverse the transit network 120a (i.e., baseline communication paths 120a-110f and 120a-110g). In contrast, because each of the other networks support communication paths that meet both the baseline and gold SLAs, then four communications paths are available that traverse the transit network 120b (i.e., baseline communication paths 120b-110f and 120b-110g and gold communication paths 120b-110f and 120b-110g). In addition, the calculation can also provide the cost associated with the available communication path based on the cost listed for each segment of the communication path. In some embodiments, sellers of communication paths can include one or more cost attribute values in the attribute database 320. In other embodiments, a cost attribute value can be listed as ‘n/a,’ in which case the cost can be obtained at a checkout or order stage in the process.

TABLE III
Calculation

| Path 115a-115d Options | SLA | Cost |
|---|---|---|
| 110a-130a-120a-130c-110f | Baseline | n/a |
| 110a-130a-120a-130c-110g | Baseline | n/a |
| 110a-130a-120b-130c-110f | Baseline | n/a |
| | Gold | $$$ + $$$ |
| 110a-130a-120b-130c-110g | Baseline | n/a |
| | Gold | $$$ + $$ |

Tables IV illustrates the results of the “best-path” algorithm. Based on the user's request to search for communication paths that meet the Gold standard, the server device 310 can determine that only two communication paths match the user's request criteria: 110a-120b-(110f or 110g). The results can separate the cost of each segment. In the case illustrated in Table IV, the segments for 110f and 110g are ranked based on cost.

TABLE IV
Results

| Interexchange | Local Exchange |
|---|---|
| Carrier (IEC) Cost | Carrier (LEC) Cost |
| 120b $$$ | 110g $$ |
| | 110f $$$ |

After the exchange operator system 300 has received an order identifying a selected communication path from a customer, the exchange operator system 300 can initiate the provisioning of the communication path between the physical ports on the exchange switch(es) that the buyer's network(s) are connected to and the physical ports on the exchange switch(es) that the seller's network(s) (e.g., access and/or transit networks 110 and 120). For example, the exchange operator system 300 can implement a Component Ethernet Virtual Circuit between the buyer's and seller's exchange ports. Depending on the characteristics of the buyer and seller carrier networks, the exchange operator system 300 can also perform some mapping of circuit attributes for interoperability. In this case, the exchange operator system 300 can alert the buyer and seller of the proposed circuit mapping. In some examples, the exchange operator system 300 can initiate the CEVC only after these mappings have been agreed to by both parties.

Both carriers then can provision their own portions of the circuit (component EVCs within their networks). Lastly, the buyer carrier can perform end-to-end testing of the entire virtual circuit to validate proper operation.

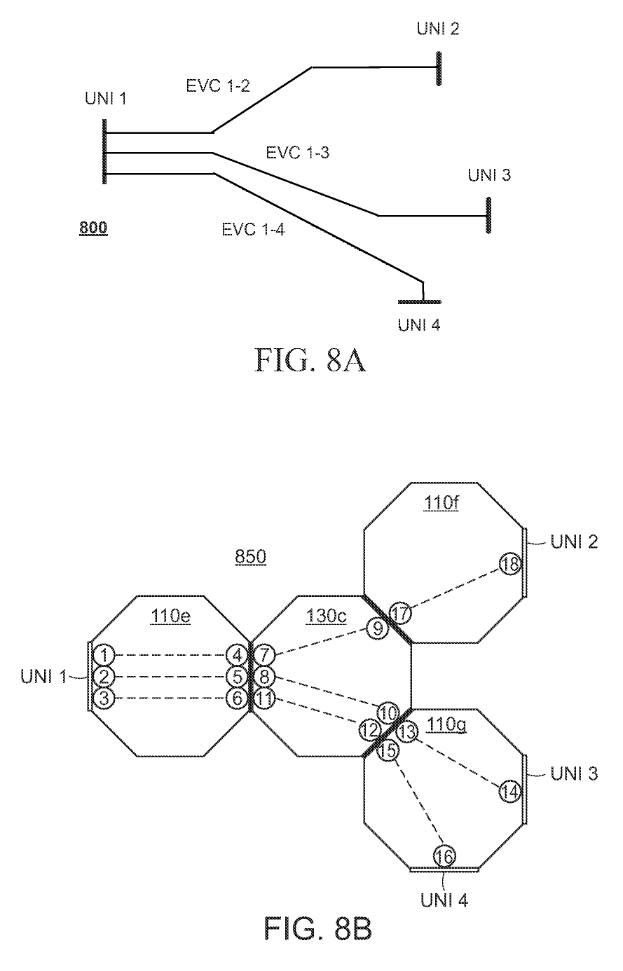

FIGS. 8A-B and 9A-B are block diagrams showing the logical connections through the exchange operator system 300 for two examples of communication paths: a set of point-to-point communication paths (e.g., E-LINE) and a multipoint-to-multipoint communication path (e.g., E-LAN). These examples illustrate how Carrier Ethernet can work across network boundaries and how the exchange switches 130 fit into the overall process. In these examples, the operator of access network 110e is a customer of the exchange operator system 300 (i.e., a buyer of off-net Carrier Ethernet), and the operators of access networks 110f and 110g are providers of access to the exchange operator system 300 (i.e., are the sellers of (wholesale) Carrier Ethernet).

FIG. 8A is block diagram showing an Ethernet Virtual Private Line to hub location configuration 800 of an example of a set of point-to-point communication paths (e.g., a hub and spoke design). The configuration 800 can be, for example, a scenario where a customer enterprise network wishes to connect three branch locations to its corporate headquarters. The configuration 800 shows the EVCs required between each of the user-to-network interfaces (UNIs), which is where the customer networks connect to the access networks 110. In this example, UNI 1 is the hub location and the other UNIs are the branch locations. The customer's service provider (the access network 110e) does not have coverage at the three branch locations. But the access network 110e is connected to the exchange switch 130c which has partner carriers (i.e., access networks 110f and 110g) that do have coverage in the desired locations.

FIG. 8B is block diagram showing a Component EVC configuration 850 associated with the EVC configuration 800. Component EVCs (CEVCs), as specified by the MEF E-NNI standard, are Ethernet virtual circuits having two end points within a single Metro Ethernet Network (MEN). One end point can terminate on an External Network-to-Network Interface (E-NNI) and the other either on a second E-NNI (a transit CEVC) or a UNI. The CEVC configuration 850 shows that EVC 1-4 is supported by three CEVCs, one in each MEN (110, 130c, 110g). These CEVCs are ‘3-6’, ‘11-12’ and ‘15-16’. VLAN mappings (not shown in the figure) can be used to connect the CEVCs on each side of the E-NNI. This can be done by the two operators on either side of the E-NNI agreeing on an S-VLAN ID for each pair of CEVC end points (the numbered circles in FIG. 8B). For example, the operator of access network 110e can agree to use S-VLAN ID=1024 to map to CEVC end point 6 in its MEN. Likewise, the operator of the exchange switch 130 can agree to use the same S-VLAN ID to map to CEVC end point 11 in its MEN. This mapping can bind the two CEVCs together. The same type of agreement can be reached between the operators of the exchange switch 130 and of the access network 110g to bind CEVC end points 12 and 15. There is no concern for mapping of customer VLAN ID since this is a point-to-point circuit not a LAN service. This completes the provisioning of EVC 1-4. Provisioning of the remaining EVCs can follow a similar procedure.

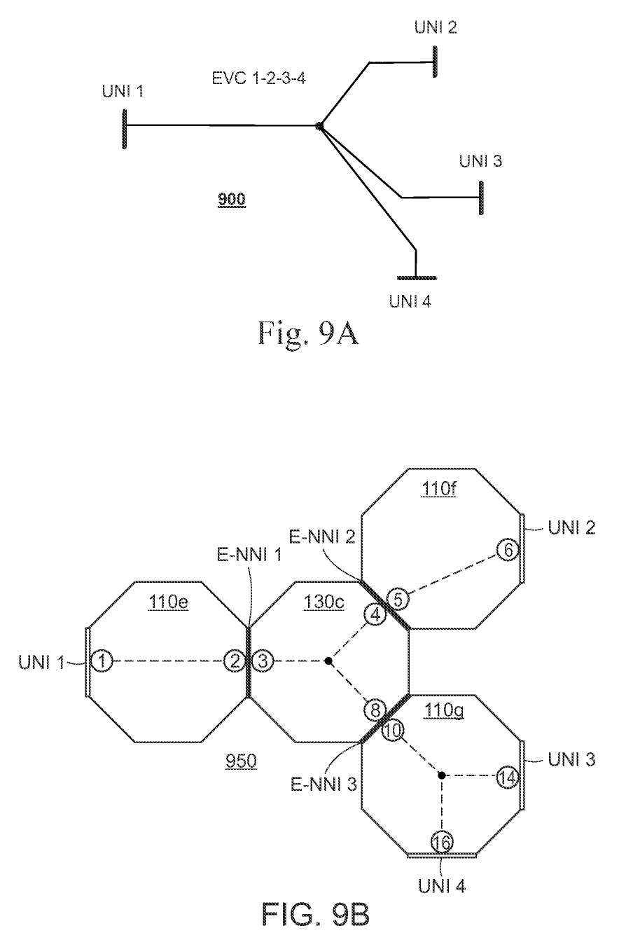

FIG. 9A is block diagram showing an Ethernet Virtual Circuit (EVC) configuration 900 of an example multipoint-to-multipoint communication path (e.g., a Ethernet Private LAN (EPLAN)). In this example, the exchange operator system 300 provides a single Ethernet Private LAN connecting four UNIs. FIG. 9B is block diagram showing a Component EVC configuration 950 associated with the EVC configuration 900. The CEVC configuration 950 shows that EVC 1-2-3-4 is supported by four CEVCs, one in each of the MENs 110e, 130c, 110f and 110g. These CEVCs are labeled ‘1-2’, ‘3-4-8’, ‘5-6’ and ‘10-14-16’. S-VLAN mappings can bind the CEVCs together at the E-NNI borders just as in configuration 850. However, since configuration 950 is a LAN service, the customer's C-VLAN ID can be preserved from ingress at any UNI to egress at any other UNI. The Ethernet frame's service provider tag (with its S-VLAN ID) can be removed prior to egress.

The configurations of FIGS. 8A-B and 9A-B can illustrate the advantages that the exchange operator system 300 can provide. The exchange operator system 300 can advantageously determine the best match for communication paths and associated carriers to achieve a desired connectivity. In addition, the exchange operator system 300 can advantageously determine the EVCs required to meet the service provider's requirements, determine the Component EVCs required to implement each EVC, establish S-VLAN-IDs mapping with adjacent Operators across each E-NNI boundary, build CEVC(s) within the Exchange(s), and/or support end-to-end testing between the service provider and off-net operator(s).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

Networks 110, 120 and/or 115 can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/or other circuit-based networks.

Carrier Ethernet can be used to provide point-to-point connectivity (e.g., new circuits and TDM replacement), point-to-multipoint (e.g., IPTV and content delivery), and/or multipoint-to-multipoint (e.g., Enterprise VPNs and Metro LANs). Carrier Ethernet advantageously provides for a lower cost per megabit and more granular bandwidth options. Carrier Ethernet shares the same basic MAC addressing and frame structure as classic Ethernet, but also can leverage certain physical layer specification and components (e.g., 10 and 100 Megabit, 1 and 10 Gigabit copper and optical interfaces). Other Carrier Ethernet aspects (e.g., tagging scheme, resiliency design, operations, administration and management (OAM)) have been optimized for carrier design requirements and operational practices. The result is a cost effective, flexible technology that can support building highly scalable and robust networks.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Attachment A
Communication Path Attributes

| Attribute | Example Parameters/Options |
|---|---|
| coverage | POP locations (e.g., city or country) |
| bandwidth | 10 M, 100 M, 1 GB, 10 GB, etc. |
| bandwidth profiles | yes/no (ability to apply CIR, CBS, EIR, |
| | EBS, CF, or CM) |
| bandwidth steps | what bandwidth increments are supported |
| service level | availability, MTTR, lead times, |
| agreement | guarantees/penalties |
| carrier Ethernet | EPL (Ethernet private line), EVPL |
| service | (Ethernet virtual private line), ELAN |
| | (Ethernet local area network), EVLAN |
| | (Ethernet virtual local area network), |
| | ETREE, ELINE (Ethernet line service) |
| transport type | Ethernet-over-SDH (EoSDH), Ethernet- |
| | over-SONET (EoSONET), Ethernet-over-ATM |
| | (EoATM), Ethernet-over-Optical, PBB-TE, |
| | ATM, Frame, MPLS, and/or other transport |
| | types |
| physical interface | speed (e.g., 10 M, 100 M, 1 GB, etc.), |
| | duplex (half or full), PHY connection |
| | type (e.g., RJ-45, SMF, MMF) |
| protection mechanism | protocol (e.g., SONET, MPLS or other), |
| | failover/back speed, aggregation |
| frame type | tagging (e.g., stacking, swapping, |
| | discarding, transparency), pbits, |
| | Ethertype, service muxing, MTU size |
| | (e.g., 1520 bytes), max number of EVCs, |
| | jumbo frame support (define range) |
| VLAN tag support | 802.1ad, 802.1Q, Cisco QinQ |
| class of service (CoS) | number of levels (e.g., 0-7), queuing |
| | mechanism, performance levels (loss, |
| | jitter, latency), oversubscription ratio |
| CoS transparency | yes/no (transparent delivery of CoS to |
| | remote endponits) |
| VUNI-RUNI tunneling | yes/no (transparent tunneling from |
| | virtual UNI to remote UNI) |
| service technology | rate limiting/traffic shaping/bandwidth |
| | profile (CIR, CBS, EIT, EBS, CF, CM), |
| | max customer MAC addresses, L2CP |
| | support, Multicast & Broadcast |
| | transparency |
| network management & | Where instrumented (NNI, UNI, EVC), |
| monitoring | how (poll frequency, SNMP, ICMP, Y1731, |
| | 802.1ag, 802.3ah), what is measured |
| | (performance, availability, |
| | utilization), ticket creation and |
| | handoff (auto or manual)? |
| end-to-end management- | yes/no |
| link/service OAM | |
| ingress/egress bandwidth | yes/no |
| management | |
| 100% bandwidth | yes/no |
| guarantee | |
| hairpin switching | yes/no |
| multicast/broadcast frame | yes/no |
| support | |
| CoS translation | yes/no |
| lead time | delivery time in days |
| reporting/notifications | yes/no |
| availability | guaranteed uptime (e.g., 100, 99.999, |
| | 99.99, 99.9, or other) |
| Max CEVCs per E-NNI | max number of services supported at E- |
| | NNI |
| time to repair | time to repair in hours |
| service protection | yes/no (e.g., protection against network |
| | anomalies such as broadcast storms, |
| | DDoS) |
| security | VLAN protection, DOS, port spanning, ARP |
| | attacks |
| call admission control | rules, where applied |

What is claimed:

1. A computerized method for determining available communication paths, the method comprising:
transmitting, from a server device, a graphical user interface to a client device, the graphical user interface comprising one or more graphical elements associated with one or more communication path attributes;
receiving, at the server device, one or more communication path request criteria based on input to at least one of the one or more graphical elements, the one or more communication path request criteria associated with the one or more communication path attributes;
determining, based on the one or more communication path request criteria, a ranked set of one or more available communication paths; and
transmitting, from the server device, the ranked set of one or more available communication paths to the client device.

2. The method of claim 1 further comprising receiving, at the server device, order information from the client device, the order information identifying a selected communication path from the ranked set of one or more available communication paths.

3. The method of claim 1 further comprising:
receiving, at the server device, a save request from the client device; and
storing in a computer storage device, based on the save request, the one or more communication path request criteria and/or at least a part of the ranked set of one or more available communication paths.

4. The method of claim 1 wherein the ranked set of one or more available communication paths comprise a search results graphical user interface, the search results graphical user interface comprising an ordered list of the one or more available communication paths and one or more graphical filter elements associated with at least one of the one or more communication path attributes, the method further comprising:
receiving, at the server device, one or more filtered communication path request criteria based on input to at least one of the one or more graphical filter elements;
filtering, based on the one or more filtered communication path request criteria, the ranked set of one or more available communication paths; and
transmitting, from the server device, the filtered ranked set of one or more available communication paths to the client device.

5. The method of claim 1 wherein the one or more graphical elements comprise: one or more text prompts, one or more drop-down menus, one or more buttons, one or more sliders, or any combination thereof.

6. The method of claim 1 wherein a first graphical element of the one or more graphical elements is associated with a first communication path attribute of the one of the one or more communication path attributes.

7. The method of claim 6 wherein the first graphical element comprises a graphical prompt enabling a user to define a first communication path request criteria of the one or more communication path request criteria, the first communication path request criteria defining a first search domain of the first communication path attribute.

8. The method of claim 7 wherein the first search domain comprises: a maximum value, a minimum value, or any combination thereof.

9. The method of claim 7 wherein the first search domain comprises a set of one or more values.

10. The method of claim 1 wherein the one or more communication path attributes comprise: one or more location attributes, a time attribute, one or more quality attributes, a virtual circuit type attribute, a protocol attribute, a bandwidth attribute, a cost attribute, or any combination thereof.

11. The method of claim 10 wherein the one or more location attributes are associated with one or more exchange switch locations.

12. The method of claim 11 wherein a first communication path criteria is associated with the one or more location attributes, the first communication path criteria identifying at least a first exchange switch location, wherein each of the available communication paths in the ranked set of one or more available communication paths comprise an exchange switch located at the first exchange switch location.

13. The method of claim 1 wherein determining the ranked set of one or more available communication paths comprises:
determining, based on the one or more communication path request criteria, a base set of one or more available communication paths; and
ranking the one or more available communication paths in the base set.

14. The method of claim 13 wherein ranking the one or more available communication paths in the base set comprises assigning one or more ranking values to the one or more available communication paths, the one or more ranking values based on a preferred communication path attribute.

15. The method of claim 13 wherein determining the base set of one or more available communication paths comprises retrieving, from an attribute database device, a set of matching communication paths, the attribute database device comprising one or more searchable communication paths.

16. The method of claim 15 wherein each of the one or more searchable communication paths comprises one or more communication path attribute values associated with the one or more communication path attributes.

17. The method of claim 15 further comprising receiving, at the server device, a request from a communication path operator to update the attribute database device.

18. The method of claim 17 wherein the request comprises a request to add a new communication path to the attribute database device, the new communication path comprising one or more communication path attribute values associated with the one or more communication path attributes.

19. The method of claim 17 wherein the request comprises a request to update an existing communication path in the attribute database device, the request to update comprising updates to one or more existing communication path attribute values of the existing communication path.

20. The method of claim 15 further comprising:
transmitting, from the server device, an update request to a communication path operator database; and
receiving, at the server device, a communication path update comprising one or more updates to the one or more searchable communication paths, wherein the one or more updates comprise updates to one or more existing communication path attribute values of the one or more searchable communication paths.

21. A computer program product, tangibly embodied in a machine-readable storage device, the computer program product including instructions being operable to cause a data processing apparatus to:
transmit, from a server device, a graphical user interface to a client device, the graphical user interface comprising one or more graphical elements associated with one or more communication path attributes;
receive, at the server device, one or more communication path request criteria based on input to at least one of the one or more graphical elements, the one or more communication path request criteria associated with the one or more communication path attributes;
determine, based on the one or more communication path request criteria, a ranked set of one or more available communication paths; and
transmit, from the server device, the ranked set of one or more available communication paths to the client device.

22. A system for determining available communication paths, the system comprising:
a server device configured to:
transmit a graphical user interface to a client device, the graphical user interface comprising one or more graphical elements associated with one or more communication path attributes;
receive one or more communication path request criteria based on input to at least one of the one or more graphical elements, the one or more communication path request criteria associated with the one or more communication path attributes;
determine, based on the one or more communication path request criteria, a ranked set of one or more available communication paths; and
transmit the ranked set of one or more available communication paths to the client device.

23. A computerized method for interconnecting communication networks, the method comprising:
connecting a first communications network to a first exchange switch, the first communications network operated by a first carrier;
receiving, from the first carrier, a first set of one or more attribute values associated with available communication paths provided by the first communications network to the first exchange switch;
connecting a second communications network to a second exchange switch, the second communications network operated by a second carrier different from the first carrier;
receiving, from the second carrier, a second set of one or more attribute values associated with available communication paths provided by the second communications network to the second exchange switch;
storing the first and second sets of one or more attribute values in an attribute database;
receiving, from a computing device associated with a buyer, data representative of a request to setup a communication path between the first and second communication networks using the first and second exchange switches; and
determining, based on the data representative of the request, a set of one or more available communication paths from the available communication paths provided by the first and second communication networks.

24. The method of claim 23 wherein the first and second exchange switches are the same.

25. The method of claim 23, wherein the first and second exchange switches are different.

26. The method of claim 25 further comprising connecting a third communications network to the first exchange switch and the second exchange switch, the third communications network operated by a third carrier, wherein at least one communication path from the set of one or more available communication paths comprises at least a segment of the third communications network.

27. The method of claim 23 wherein the first and second communication networks comply with minimum requirements before connecting to the first or second exchange switches.
